(19) United States
(12) Patent Application Publication
(10) Pub. No.: US 2012/0188411 A1
(43) Pub. Date: Jul. 26, 2012

(54) METHOD AND APPARATUS FOR PROCESSING IMAGE

(75) Inventor: In-ra Jang, Gwangmyeong-si (KR)

(73) Assignee: Samsung Electronics Co., Ltd., Suwon-si (KR)

(21) Appl. No.: 13/271,333

(22) Filed: Oct. 12, 2011

(30) Foreign Application Priority Data
Jan. 25, 2011 (KR) 10-2011-0007322

(51) Int. Cl. H04N 5/262; H04N 5/228; H04N 5/225

(52) U.S. Cl. 348/239; 348/207.99; 348/222.1; 348/E05.051; 348/E05.024

(57) ABSTRACT

An image processing apparatus, in which mapping information between preset sound patterns and preset visual effects is stored in a memory unit, a sound is obtained, and a sound pattern of the obtained sound is determined. Then, an image is captured or adjusted by applying preset setting data thereto to apply a preset visual effect corresponding to the sound pattern to the captured image.

### CROSS-REFERENCE TO RELATED PATENT APPLICATION

This application claims the priority benefit of Korean Patent Application No. 10-2011-0007322, filed on Jan. 25, 2011, in the Korean Intellectual Property Office, the entirety of which is incorporated herein by reference.

### BACKGROUND

1. Field

One or more aspects of the invention relate to image processing, and more particularly, to an image processing technique for obtaining an image to which a visual-effect is added in an effective and user-friendly manner.

2. Description of the Related Art

In image processing apparatuses, such as a camera or a camcorder, images having various atmospheres may be generated from the same image by changing hardware setting values through manipulation by a user or processing image data according to a mode selected by the user.

An image processing apparatus provides various shooting modes or various style modes in such a manner that a user may select a desired mode from among such modes. Examples of the various shooting modes include a night mode, a portrait mode, a landscape mode, etc. Examples of the various style modes include a clear mode, a calm mode, a sepia mode, a cool mode, a classic mode, etc.

A user may optionally set such shooting modes or style modes in an image processing apparatus. That is, the user may select a desired mode from among such modes set in the image processing apparatus, or may use a default mode. The user may need to learn such modes to select a mode appropriate for an atmosphere to capture an image.

### SUMMARY

According to one aspect of the invention, there is provided an image processing apparatus including a memory unit for storing a mapping table, the mapping table representing that at least one of preset sound patterns corresponds to at least one piece of preset setting data for controlling image capturing; a sound sensor for obtaining sound; a controller for determining one of the preset sound patterns to be a sound pattern of the obtained sound; and an imaging unit for capturing an image. The controller applies to the imaging unit preset setting data corresponding to the sound pattern from among the at least one piece of preset setting data in the mapping table.

Each of the at least one piece of preset setting data may include at least one from among an aperture value, a shutter speed, an International Standards Organization (ISO) sensitivity, and an image sensor setting value.

The preset sound patterns may include a first pattern and a second pattern. The first pattern may correspond to first data as the at least one piece of preset setting data in the mapping table. The second pattern may correspond to second data as the at least one piece of preset setting data in the mapping table. At least one of a first condition whereby an aperture value included in the first data is greater than an aperture value included in the second data, and a second condition whereby a shutter speed included in the first data is faster than a shutter speed included in the second data may be satisfied.

Time-domain characteristics of the first pattern may be different from time-domain characteristics of the second pattern, or frequency-domain characteristics of the first pattern may be different from frequency-domain characteristics of the second pattern. Each of the time-domain characteristics may include at least one from among an amplitude variation in the time domain and an autocorrelation, and wherein each of the frequency-domain characteristics may include frequency distribution characteristics.

The controller may adjust at least some of second preset setting data corresponding to a sound pattern determined according to a strength (volume) of the obtained sound. The second preset setting data may include at least one from among an aperture value, a shutter speed, an ISO sensitivity, and an image sensor setting value.

According to another aspect of the invention, there is provided an image processing method including storing a mapping table in a memory unit, the mapping table representing that at least one of preset sound patterns corresponds to at least one piece of preset setting data for controlling image capturing; obtaining a sound; determining one of the preset sound patterns to be a sound pattern of the obtained sound; and capturing an image by applying preset setting data corresponding to the determined sound pattern from among the at least one piece of preset setting data in the mapping table.

Each of the at least one piece of preset setting data may include at least one from among an aperture value, a shutter speed, an ISO sensitivity, and an image sensor setting value.

The preset sound patterns may include a first pattern and a second pattern. The first pattern may correspond to first data as the at least one piece of preset setting data in the mapping table. The second pattern may correspond to second data as the at least one piece of preset setting data in the mapping table. At least one of a first condition whereby an aperture value included in the first data is greater than an aperture value included in the second data and a second condition whereby a shutter speed included in the first data is faster than a shutter speed included in the second data may be satisfied.

Time-domain characteristics of the first pattern may be different from time-domain characteristics of the second pattern, or frequency-domain characteristics of the first pattern may be different from frequency-domain characteristics of the second pattern. Each of the time-domain characteristics may include at least one from among an amplitude variation in the time domain and autocorrelation, and wherein each of the frequency-domain characteristics may include frequency distribution characteristics.

The capturing of the image may include adjusting at least some of preset setting data corresponding to a sound pattern determined according to a strength of the obtained sound. The preset setting data may include at least one from among an aperture value, a shutter speed, an ISO sensitivity, and an image sensor setting value.

According to another aspect of the invention, there is provided an image processing apparatus including a memory unit for storing a mapping table in a memory unit, the mapping table representing that preset sound patterns correspond to preset visual effects, respectively; a sound sensor for obtaining sound; a controller for determining one of the preset sound patterns to be a sound pattern of the obtained sound; and an imaging unit for capturing an image. The controller performs at least one from among controlling the imaging unit to apply a preset visual effect corresponding to the determined sound pattern in the mapping table to the captured image; and correcting (adjusting) the captured image corresponding to the determined sound pattern in the mapping table to the captured image.

At least one of the preset visual effects include setting data for controlling the capturing of the image, the setting image including at least one from among an aperture value, a shutter speed, an ISO sensitivity, and an image sensor setting value.

The controller may control an operation of the imaging unit by applying setting data included in the preset visual effect corresponding to the determined sound pattern to the imaging unit.

At least one of the preset visual effects includes an image data processing mode for correcting the captured image.

The controller may correct the captured image by correcting the captured image according to an image data processing mode included in the preset visual effect corresponding to the determined sound pattern.

The image data processing mode include correction data regarding at least one from among brightness, chroma, contrast, and color balance. The controller may control correction data of an image data processing mode included in a preset visual effect corresponding to a sound pattern determined according to a strength of the obtained sound.

The image data processing mode include processing data regarding at least one from among a vignetting effect, a fish eye effect, a watercolor painting effect, and a synthetic effect of adding an object. The controller may adjust a correction level of processing data of an image data processing mode, which is included in a preset visual effect corresponding to a sound pattern determined according to a strength of the obtained sound.

According to another aspect of the invention, there is provided an image processing method including storing a mapping table in a memory unit, the mapping table representing that preset sound patterns correspond to preset visual effects, respectively; obtaining a sound; determining one of the preset sound patterns to be a sound pattern of the obtained sound; and capturing an image. The capturing of the image includes at least one from among applying setting data for controlling the capturing of the image to apply a preset visual effect corresponding to the determined sound pattern in the mapping table to the captured image; and correcting the captured image corresponding to the determined sound pattern in the mapping table to the captured image.

According to another aspect of the invention, there is provided an image processing apparatus including a memory unit for storing a mapping table representing that at least one of preset sound patterns corresponds to at least one image data processing mode for correcting image data; a sound sensor for obtaining a sound; a controller for determining one of the preset sound patterns to be a sound pattern of the obtained sound; and an imaging unit for obtaining the image data by capturing an image. The controller may adjust the image data according to an image data processing mode corresponding to the determined sound pattern from among the at least one image data processing mode in the mapping table.

According to another aspect of the invention, there is provided an image processing method including storing a mapping table in a memory unit, the mapping table representing that at least one of preset sound patterns corresponds to at least one image data processing mode for correcting image data; obtaining a sound; determining one of the preset sound patterns to be a sound pattern of the obtained sound; obtaining the image data by capturing an image; and adjusting the image data according to an image data processing mode corresponding to the determined sound pattern from among the at least one image data processing mode in the mapping table.

According to another aspect of the invention, there is provided an image processing apparatus including a memory unit for storing audio data and image data; and a controller for receiving the audio data, receiving the image data, and adjusting the image data by applying to the image data a preset visual effect corresponding to the audio data.

According to another aspect of the invention, there is provided an image processing method including receiving audio data; receiving image data; and adjust the image data by applying a preset visual effect corresponding to the audio data to the image data.

### BRIEF DESCRIPTION OF THE DRAWINGS

The above and other features of the invention will become more apparent by describing in detail exemplary embodiments thereof with reference to the attached drawings in which:

FIG. 1 is a block diagram of an image processing apparatus, according to an embodiment of the invention;

FIG. 2 is a diagram illustrating an image having a visual effect corresponding to a sound pattern, according to an embodiment of the invention;

FIG. 3 is a diagram illustrating an image having a visual effect corresponding to a sound pattern, according to another embodiment of the invention;

FIG. 4 is a diagram illustrating an image having a visual effect corresponding to a sound pattern, according to another embodiment of the invention;

FIG. 5 illustrates an image data structure that includes mapping information between a sound pattern and a visual effect, according to an embodiment of the invention;

FIG. 6 is a flowchart illustrating an image processing method, according to an embodiment of the invention;

FIG. 7 is a flowchart illustrating an image processing method, according to another embodiment of the invention; and

FIG. 8 is a flowchart illustrating an image processing method, according to yet another embodiment of the invention.

### DETAILED DESCRIPTION

Hereinafter, exemplary embodiments of the invention will be described in detail with reference to the accompanying drawings. However, the invention is not limited to the exemplary embodiments set forth herein. Like reference numerals denote like elements throughout the drawings.

The terms used herein, e.g., ‘embodiment’, ‘example, ‘aspect’, and ‘illustrate’, should not be understood to mean that the aspects (or designs) of the invention described herein are better than or have advantages over other aspects (or designs) of the invention.

In general, the terms used herein, e.g., ‘component’, ‘module’, ‘system’, and ‘interface’ include hardware, software, firmware, or any combination of hardware, software and firmware.

The term ‘or’ should be construed as ‘inclusive OR’ other than ‘exclusive OR.’ That is, unless otherwise instructed or unless otherwise clearly indicated according to context, an expression that “x uses ‘a’ or ‘b’” may mean one of natural inclusive permutations.

As used herein, the singular terms ‘a’ or ‘an’ are intended to include the plural forms as well, unless otherwise instructed or unless otherwise clearly indicated according to context.

The term ‘and/or’ includes any and all combinations of one or more associated listed items.

The terms ‘comprise’ (or ‘include’) and/or ‘comprising’ (or ‘including’), when used in this specification, specify the presence of stated features, integers, operations, modules, elements, and/or components, but do not preclude the presence or addition of one or more other features, integers, operations, modules, elements, components, and/or groups thereof.

Also, although the terms ‘first’, ‘second’, ‘third’, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the invention.

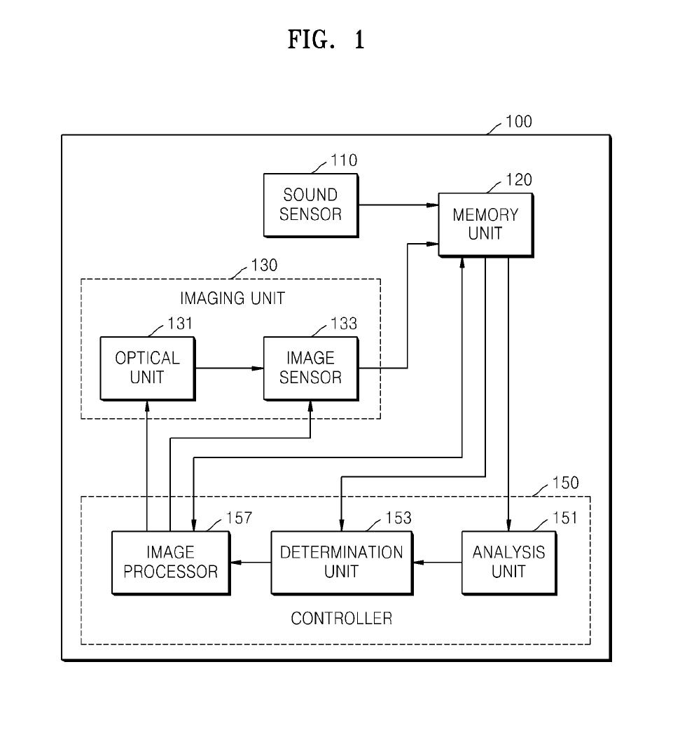

FIG. 1 is a block diagram of an image processing apparatus 100, according to an embodiment of the invention. The image processing apparatus 100 may be an apparatus capable of capturing a still image or a moving image, and processing a captured or stored image data. Examples of the image processing apparatus 100 include a digital camera, a camera phone, a personal digital assistant, a portable multimedia player, a camcorder, a smart phone, a lab top computer, a desk top computer, and a digital television (TV).

The image processing apparatus 100 may include a sound sensor 110, a memory unit 120, an imaging unit 130, and/or a controller 150. The imaging unit 130 may include an optical unit 131, and/or an image sensor 133. The controller 150 may include an analysis unit 151, a determination unit 153, and/or an image processor 157. According to an embodiment of the invention, the controller 150 may include at least one processor configured to perform an operation of each of the analysis unit 151, the determination unit 153, and/or the image processor 157.

The image processing apparatus 100 may further include a user interface unit (not shown). The user interface unit may provide a user with a preview or a view of a captured image or moving image, and/or may display a current status of the image processing apparatus 100. The user interface unit may also provide a user interface via which the user may select or change, for example, a shooting mode, a style mode, or setting data. That is, via the user interface unit, the user may input information or may output information and/or data via a liquid crystal display (LCD), a speaker, a touch screen, or buttons. For example, the user interface unit may provide a user interface in such a manner that the user may activate or deactivate a hybrid mode therewith. According to an embodiment of the invention, the hybrid mode may be a mode in which sound is analyzed, and a visual effect corresponding to an atmosphere associated with the sound is automatically applied to an image based on the analysis. Thus, when the hybrid mode is activated in the image processing apparatus 100, a visual effect corresponding to an atmosphere associated with ambient sound may be automatically selected without the user's manipulation. Accordingly, it is possible to conveniently obtain a captured image to which a visual effect is added.

The sound sensor 110 may obtain ambient sound of the image processing apparatus 100. For example, the sound sensor 110 may include a microphone. The sound may be obtained by the sound sensor 110 the moment the image processing apparatus 100 captures an image, or may be obtained in a predetermined time period before or after an image is captured. For example, the sound may be obtained in a time period between when a half-shutter signal for driving at least one part of the imaging unit 130 is input and when a full-shutter signal is input. Otherwise, the sound may be obtained in real time and in a time period between when the hybrid mode is activated and when the full-shutter signal is input, may be periodically obtained, or may be obtained in a predetermined time period.

The memory unit 120 may receive and store the sound obtained by the sound sensor 110. The memory unit 120 may receive and store an image or image data captured by the imaging unit 130. The memory unit 120 may also receive and store image data processed by the image processor 157 included in the controller 150. The memory unit 120 may include volatile memory and/or nonvolatile memory. For example, the volatile memory may be Static Random Access Memory (SRAM) or Dynamic Random Access Memory (DRAM). The nonvolatile memory may be a Read Only Memory (ROM), flash memory, a hard disk, a Secure Digital (SD) Memory Card), or Multi-Media Card (MMC).

According to an embodiment of the invention, the memory unit 120 may store a mapping table corresponding at least one of preset sound patterns to predetermined setting data for controlling capturing or adjusting of an image.

For example, the preset sound patterns may include a calm sound pattern and/or a loud sound pattern. The preset sound patterns may be classified into music patterns, such as a classical music pattern, a jazz pattern, and/or a rock pattern according to music genre. The music patterns may also be classified into sub patterns, for example, calm sound patterns and/or loud sound patterns. The preset sound patterns may also include speech patterns, such as a female pattern, a male pattern and/or a child pattern. The predetermined setting data may include at least one from among an aperture value, a shutter speed, an ISO sensitivity, and an image sensor setting value. That is, the preset setting data may be used to control capturing of an image or to control the imaging unit 130. Also, each of the aperture value, the shutter speed, the ISO sensitivity, and the image sensor setting value may be used to increase, decrease, or update the existing value or a value set according to the existing setting.

For example, the preset sound patterns included in the mapping table may include a first pattern and a second pattern. The first pattern may correspond to first data as preset setting data in the mapping table, and the second pattern may correspond to second data as preset setting data in the mapping table. For example, at least one of a first condition whereby an aperture value included in the first data is greater than an aperture value included in the second data, and a second condition whereby a shutter speed included in the first data is faster than a shutter speed included in the second data may be satisfied. The time-domain characteristics of the first pattern may be different from those of the second pattern, or the frequency-domain characteristics of the first pattern may be different from those of the second pattern. Each of the time-domain characteristics may include at least one from among an amplitude variation in a time domain and autocorrelation. Each of the frequency-domain characteristics may include frequency distribution characteristics.

According to another embodiment of the invention, the memory unit 120 may store a mapping table indicating that at least one of the preset sound patterns corresponds to at least one image data processing mode for correcting (adjusting) image data. In the image data processing mode, a captured image or image data is corrected. For example, the image data processing mode may include correction data regarding at least one from among brightness, chroma, contrast, and color balance. Also, the image data processing mode may include processing data to apply at least one from among a vignetting effect, a fish-eye effect, a watercolor painting effect, and a synthetic effect of adding an object.

According to another embodiment of the invention, the memory unit 120 may store a mapping table indicating that the preset sound patterns correspond to preset visual effects, respectively. At least one of the preset visual effects may include setting data for controlling capture of an image. Also, at least one of the preset visual effects may include an image data processing mode for correcting a captured image.

The imaging unit 130 may include the optical unit 131 and/or the image sensor 133. The imaging unit 130 may obtain image data by capturing an image. The imaging unit 130 may also adjust setting data or apply setting data determined by the controller 150, under control of the controller 150. For example, the imaging unit 130 may apply adjusted or determined setting data to capture an image to obtain image data to which a particular visual effect is applied.

Although not shown, the optical unit 131 may include a lens for condensing an optical signal, an iris for controlling the optical intensity of the optical signal, a shutter for controlling input of the optical signal, and so on. For example, the lens may include a zoom lens for decreasing or increasing an imaging angle according to a focal distance and/or a focus lens for focusing on a subject. A plurality of lenses may be formed separately or may be formed together as a group of lenses. The shutter may include a mechanical shutter, a screen of which moves upward or downward. Also, the shutter may act as an electrical shutter because the image sensor 133 may control supply of an electrical signal.

Also, the optical unit 131 may include a motor for driving the lens, the iris, and/or the shutter. For example, the motor may control a location of the lens, opening or closing of the iris, or operate the shutter to perform auto focusing, control exposure, adjusting of the iris, or performing of a focus change. The motor may receive setting data or a control signal from the controller 150 and control the aperture value and/or the shutter speed.

The image sensor 133 may receive an optical signal from the optical unit 131 and transform the optical signal into an electrical signal. For example, the image sensor 133 may be a Charge-Coupled Device (CCD) sensor or a Complementary Metal Oxide Semiconductor (CMOS) sensor.

The controller 150 may receive an obtained sound from the memory unit 120. Also, the controller 150 may bypass the memory unit 120 and may directly receive the obtained sound from the sound sensor 110. The controller 150 may access preset sound patterns, at least one piece of setting data, at least one image data processing mode, preset visual effects, or a mapping table, which are stored in the memory unit 120. The controller 150 may determine one of the preset sound patterns to be a sound pattern of the obtained sound.

Also, the controller 150 may process image data. For example, the controller 150 may perform image data processing for improving image quality, e.g., noise reduction in image data, gamma correction, color filter interpolation, a color matrix, color correction, or color enhancement. The controller 150 may generate an image data file by compressing processed image data. Also, the controller 150 may transmit the processed image data or the image data file to the memory unit 120. The image data may be compressed in a reversible or irreversible compression format. For example, the image data may be compressed in a Joint Photographic Experts Group (JPEG) format or a JPEG 2000 format. Also, the controller 150 may, for example, perform sharpness control, color control, blurring, edge enhancement, image analysis, image recognition, and image effect processing on image data.

Also, the controller 150 may control capturing of an image or may control the imaging unit 130. For example, the controller 150 may adjust setting data of the imaging unit 130, or may apply setting data determined by the controller 150 to the imaging unit 130.

According to an embodiment of the invention, the controller 150 may apply to the imaging unit 130 preset setting data that corresponds to a determined sound pattern from among at least one piece of preset setting data in a mapping table. Also, the controller 150 may adjust at least some part of preset setting data corresponding to a sound pattern determined according to the strength (volume) of the obtained sound.

According to another embodiment of the invention, the controller 150 may correct image data according to an image data processing mode corresponding to a determined sound pattern from among at least one image data processing mode in a mapping table. Here, the image data may be obtained by capturing of an image by the imaging unit 130. Also, the controller 150 may adjust correction data according to an image data processing mode that corresponds to a sound pattern determined according to the strength of the obtained sound. Also, the controller 150 may adjust the correction level of processing data corresponding to the sound pattern determined according to the strength of the obtained sound.

According to another embodiment of the invention, the controller 150 may control the imaging unit 130 to apply a preset visual effect corresponding to a sound pattern in a mapping table to a captured image and/or may correct the captured image. Here, the controller 150 may control the imaging unit 130 by applying to the imaging unit 130 setting data included in a preset visual effect corresponding to a determined sound pattern. Also, the controller 150 may correct a captured image by correcting the captured image according to an image data processing mode included in a preset visual effect corresponding to a determined sound pattern. Also, the controller 150 may adjust correction data according to an image data processing mode, which is included in a preset visual effect corresponding to a sound pattern determined according to the strength of a determined sound pattern. Also, the controller 150 may adjust the correction level of processing data according to an image data processing mode, which is included in a preset visual effect corresponding to a sound pattern determined according to the strength of a determined sound pattern.

Also, the controller 150 may determine a preset visual effect corresponding to a sound pattern determined using a preset equation, a preset function, a hardware module, a software module, or may adjust at least some part of a preset visual effect without having to use a mapping table. Also, the controller 150 may directly determine a preset visual effect corresponding to an obtained sound without having to determine a sound pattern corresponding to the obtained sound. In this case, the analysis unit 151 included in the controller 150 may be bypassed or omitted.

The analysis unit 151 may receive the obtained sound from the memory unit 120. Also, the analysis unit 151 may directly receive the obtained sound from the sound sensor 110 bypassing the memory unit 120. The analysis unit 151 may analyze time-domain characteristics and/or frequency-domain characteristics of the obtained sound. The time-domain characteristics may include at least one from among an amplitude variation in the time domain and an autocorrelation. The frequency-domain characteristics may include frequency distribution characteristics. For example, the analysis unit 151 may obtain analysis data regarding musical beats, a music time pattern, or rhythms by analyzing the amplitude variation in the time domain and/or the autocorrelation to determine whether a sound corresponds to one of patterns classified according to music genre. Also, the analysis unit 151 may obtain analysis data by analyzing the frequency distribution characteristics to distinguish between speech and music, classify speech as a female pattern, a male pattern, or a child pattern, or identify a particular musical instrument used to play music. Also, the analysis unit 151 may calculate the strength of the obtained sound. For example, the strength of the obtained sound may be an average or highest strength in a preset time domain of the obtained sound. The strength of the obtained sound may be calculated in decibels (dBs). Also, the strength of the obtained sound may be specified in the analysis data.

The determination unit 153 may receive the analysis data of the obtained sound from the analysis unit 151. The determination unit 153 may receive preset sound patterns included in a mapping table from the memory unit 120. The determination unit 153 may determine one from among the preset sound patterns in the mapping table to be a sound pattern of the obtained sound based on the analysis data of the obtained sound. For example, the determination unit 153 may compare the analysis data of the obtained sound with the preset sound patterns, and determine (identify) a sound pattern most similar to the obtained sound from among the present sound patterns to be a sound pattern of the obtained sound. Also, the determination unit 153 may calculate a correlation between the analysis data of the obtained sound and each of the preset sound patterns, and determine a sound pattern having the largest correlation or a correlation equal to or greater than a predetermined value from among the preset sound patterns to be a sound pattern of the obtained sound.

The image processor 157 may receive the determined sound pattern from the determination unit 153. The image processor 157 may access the mapping table stored in the memory unit 120 to obtain a preset visual effect, preset setting data, or an image data processing mode corresponding to the determined sound pattern.

The image processor 157 may apply the preset setting data corresponding to the determined sound pattern to a captured image or the imaging unit 130. Also, if the preset visual effect corresponding to the determined sound pattern includes the preset setting data, the image processor 157 may apply the preset setting data included in the preset visual effect corresponding to the determined sound pattern to a captured image or the imaging unit 130. For example, the image processor 157 may apply at least one from among an aperture value, a shutter speed, an ISO sensitivity, and an image sensor setting value to the optical unit 131 and/or the image sensor 133 included in the imaging unit 130. If the image processor 157 controls the preset setting data to the captured image or the imaging unit 130, image data to which the preset visual effect is added (applied) or an image data file may be obtained via the imaging unit 130. Also, the image processor 157 may receive information regarding the strength of the sound or the analysis data specifying the strength of the sound from the analysis unit 151 or the determination unit 153. The image processor 157 may adjust at least some part of the preset setting data corresponding to the sound pattern determined by the strength of the sound. Also, the image processor 157 may obtain the image data file by image processing, e.g., compressing, the obtained image data.

The image processor 157 may correct a captured image or image data according to the image data processing mode corresponding to the determined sound pattern. Here, the captured image or the image data may be obtained by capturing an image by the imaging unit 130. For example, the image data processing mode may include correction data for at least one from among brightness, chroma, contrast, and color balance. The image processor 157 may correct the captured image or image data to apply a preset visual effect corresponding to the correction data thereto using the correction data. Also, the image data processing mode may include processing data regarding at least one from among the vignetting effect, the fish-eye effect, the watercolor painting effect, and the synthetic effect of adding an object. The image processor 157 may correct the captured image or image data to apply a preset visual effect corresponding to the processing data thereto using the correction data. Also, the image processor 157 may adjust the correction level or correction data for processing data of an image data processing mode corresponding to a sound pattern determined by the strength of the obtained sound. Also, the image processor 157 may store the corrected image or image data in the memory unit 120. In this case, the image processor 157 may compress the corrected image or image data.

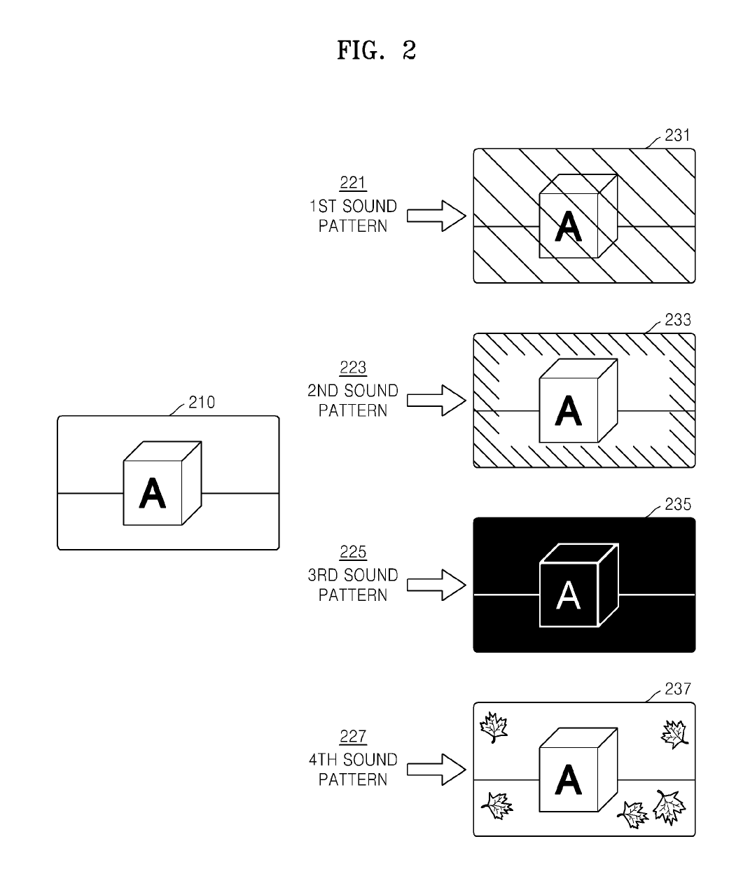

The image processing apparatus 100 will now be described in greater detail, focusing on examples of an image having a visual effect applied corresponding to a sound pattern and an example of an image data file illustrated in FIGS. 2 to 5.

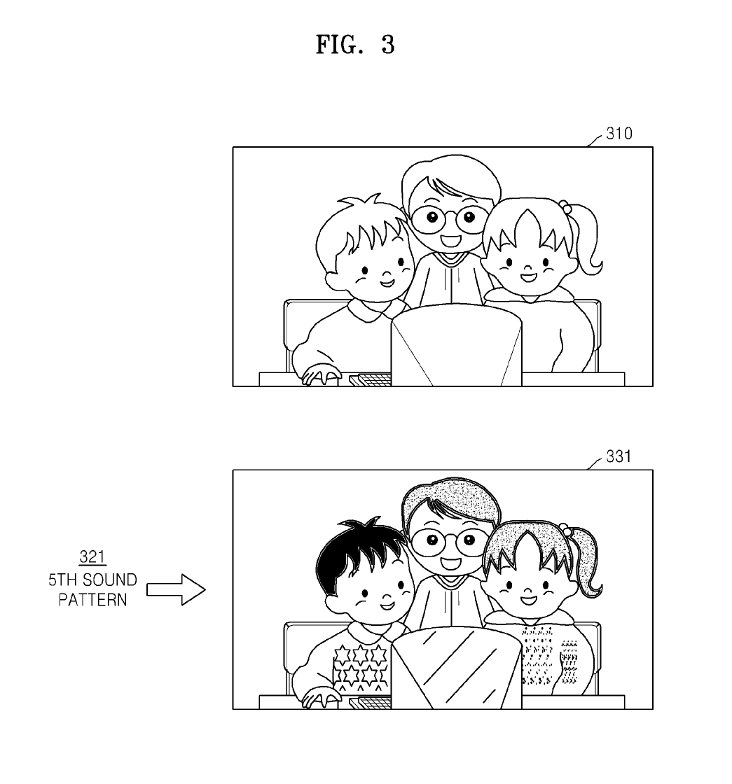

Each of a first sound pattern 221, a second sound pattern 223, a third sound pattern 225, and a fourth sound pattern 227 are illustrated in FIG. 2, and a fifth sound pattern 321 illustrated in FIG. 3 are sound patterns corresponding to a sound obtained by the sound sensor 110 of FIG. 1, and may be determined by, for example, the controller 150 (e.g., the analysis unit 151) of FIG. 1. That is, each of the first to fifth sound patterns 221, 223, 225, 227 and 321 may be identified or classified as a sound pattern corresponding to the obtained sound from among preset sound patterns.

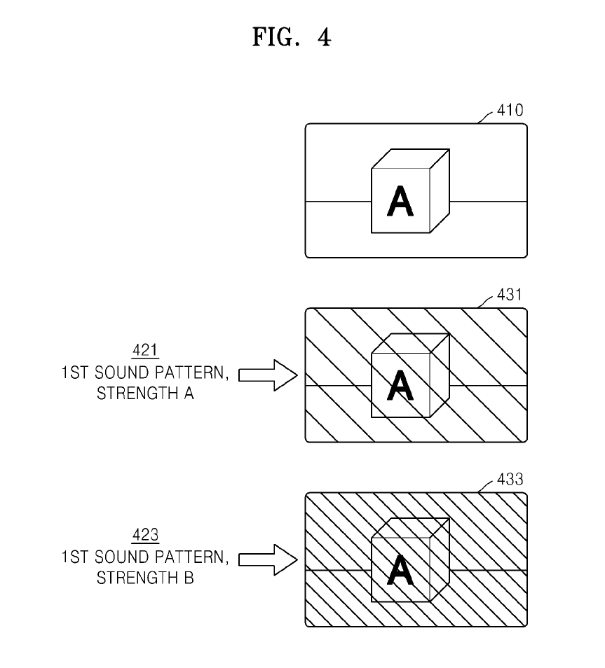

An image 210 of FIG. 2, an image 310 of FIG. 3, and an image 410 of FIG. 4 may represent image data obtained by the image processing apparatus 100 of FIG. 1 when the hybrid mode is not activated. That is, each of the image 210, the image 310, and the image 410 may be an image or image data to which a visual effect has not been added. If the hybrid mode is activated, the image 210 may have no sound pattern corresponding to the obtained sound, or no visual effect corresponding to a sound pattern corresponding to the obtained sound.

Examples of a preset setting value, an image data processing mode, or a preset visual effect corresponding to the sound pattern will be described according to a mapping table.

In FIG. 2, an image 231 may be an example of the image 210 or image data to which a first visual effect corresponding to the first sound pattern 221 in a mapping table stored in the memory unit 120 is applied.

For example, the first sound pattern 221 may be a calm sound pattern. A preset first visual effect corresponding to the first sound pattern 221 may be an adjustment of brightness to darken an image. Also, the first visual effect may include setting data for controlling capturing of the image 210. The setting data may be an adjustment of the image 210 to have an aperture value greater than a default aperture value or to have a shutter speed faster than a default shutter speed. Also, the first visual effect may include an image data processing mode for correcting the image 210 or the image data. The image data processing mode may include correction data for controlling the image 210 to have a brightness less than a default brightness.

Alternatively, the first sound pattern 221 may be a wind sound pattern. Preset setting data corresponding to the first sound pattern 221 may concern a cool style that is a type of visual effect giving cooling feeling with bright colors. The controller 150 may adjust a setting value of the image sensor 133 of FIG. 1 in such a manner that the cool style may be reflected in capturing of the image 210 according to the first visual effect. For example, the setting value of the image sensor 133 may be adjusted to increase the sensitivity for blue or green. Also, an image data processing mode corresponding to the first sound pattern 221 may include correction data regarding color balance for increasing a relative appearance of blue or green. Also, a preset visual effect corresponding to the first sound pattern 221 may include at least one from among the preset setting data and the image data processing mode regarding the cool style.

An image 233 may be an example of either the image 210 or the image data to which a second visual effect corresponding to the second sound pattern 223 in the mapping table stored in the memory unit 120 is applied. For example, the second sound pattern 223 may be a calm music pattern. If analysis data of the obtained sound has characteristics such as musical beats, a music time pattern, or rhythms, and a time cycle in which a minimum value and a maximum value appear in an autocorrelation graph is less than a predetermined threshold level, then the controller 150 may determine the obtained sound as a calm music pattern. An image data processing mode corresponding to the second sound pattern 223 may concern the vignetting effect or a lomo effect. For example, when the vignetting effect is added to the image 233, an edge region of the image 233 may be darkened relative to a central region of the image 233. A preset visual effect corresponding to the second sound pattern 223 may include preset setting data and/or the image data processing mode regarding the vignetting effect or the lomo effect. For example, the preset setting data regarding the vignetting effect or the lomo effect may be a control signal or a setting value for a process of darkening an edge region of the image 233 using a lens characteristic of the optical unit 130.

An image 235 may be an example of either the image 210 or the image data to which a third visual effect corresponding to the third sound pattern 225 in the mapping table stored in the memory unit 120 is added. For example, the third sound pattern 225 may be a loud music or rock music pattern. An image data processing mode corresponding to the third sound pattern 225 may be a negative image effect.

An image 237 may be an example of either the image 210 or the image data to which a fourth visual effect corresponding to the fourth sound pattern 227 in the mapping table stored in the memory unit 120 is added. For example, the fourth sound pattern 227 may be a calm music pattern. If the obtained sound belongs to a calm music pattern, then the controller 150 may determine the obtained sound as a classical music pattern in consideration of rhythms or frequency distribution characteristics based on analysis data of the obtained sound. An image data processing mode corresponding to the fourth sound pattern 227 may be the synthetic effect of adding an object. For example, if the synthetic effect is added to the image 237, an object related to fallen leaves may be added to the image 210 or the image data. Also, if the synthetic effect is added to the image 237, an object related to a star, a note, a heart, a balloon, or a drum may be synthesized with the image 210 or the image data according to a corresponding sound pattern.

In FIG. 3, an image 331 may be an example of a captured image or image data to which a fifth visual effect corresponding to the fifth sound pattern 321 in the mapping table stored in the memory unit 120 is added. For example, the fifth sound pattern 321 may be a loud sound pattern or a child pattern. The controller 150 may determine the obtained sound as a child pattern in consideration of analysis data, e.g., frequency distribution characteristics, of the obtained sound. According to preset setting data corresponding to the fifth sound pattern 321, the captured image may be captured in such a manner that chroma may be increased and the facial colors of characters and primary colors may look better. For example, the controller 150 may control a setting value of the image sensor 133 to increase the chroma of the image 310. Also, the fifth visual effect corresponding to the fifth sound pattern 321 may be an image data processing mode, in which chroma may be increased and the facial colors of characters and primary colors may look better. For example, the controller 150 may correct the captured image or the image data to increase the chroma of the image 310. Also, the fifth visual effect corresponding to the fifth sound pattern 321 may include the preset setting data and/or the image data processing mode.

Referring back to FIG. 1, the image processing apparatus 100 may analyze ambient sound and a captured image together to recognize an ambient environment based on various information. For example, the mapping table stored in the memory unit 120 may include mapping information regarding image patterns, preset sound patterns, and preset visual effects that include preset setting data or an image data processing mode. In the controller 150, the analysis unit 151 may further analyze patterns of the image together with sound. The analysis unit 151 may obtain analysis data regarding the sound and image, and the determination unit 153 may determine a sound pattern and/or an image pattern based on this analysis data. The image processor 157 may apply preset setting data, an image data processing mode, or a preset visual effect included in the mapping table, which corresponds to the determined sound pattern and/or image pattern. Also, the sound pattern or the image pattern need not be determined separately buy may be determined together as one preset complex pattern. The image processor 157 may apply the preset setting data, the image data processing mode, or the preset visual effect corresponding to the preset complex pattern. For example, the controller 150 may determine the pattern of the image to be a child pattern that is a complex pattern based on a sound of children and the image 310, and may apply a visual effect corresponding to the child pattern to the image.

Table 1 shows a mapping table illustrating mapping information between a sound pattern and a visual effect, according to an embodiment of the invention. In the mapping table stored in the memory unit 120 of FIG. 1, a ‘classification’ column, an ‘effect’ column, and a ‘visual effect B’ column included in the mapping table shown in Table 1 may be omitted. In Table 1, ‘default’ may denote a sound pattern regarding sound that cannot be classified as at least one from among music and speech. Also, the obtained sound may be classified into a calm sound pattern and a loud sound pattern, based on analysis data of the obtained sound. The time-domain characteristics of the calm sound pattern may be different from those of the loud sound pattern according to preset classification criteria. The frequency-domain characteristics of the calm sound pattern may also be different from those of the loud sound pattern according to preset classification criteria.

TABLE 1

| | | Visual effect A | | | | | | | | | Visual |
|---|---|---|---|---|---|---|---|---|---|---|---|
| | | Setting data | | | | | | | | | effect B |
| | | | | ISO | | Image data processing mode | | | | | . |
| Classi- | Sound | Aperture | Shutter | sensi- | | | Bright- | | | | . |
| fication | pattern | value | Speed | tivity | . . . | Effect | ness | contrast | chroma | . . . | . |
| Default | Calm | 1-stop | 1-stop | 100 | . . . | — | — | — | . . . | . . . | Calm |
| | | increase | decrease | | | | | | | | Style |
| | Loud | — | — | — | . . . | — | +2 | +2 | +2 | . . . | Vivid |
| | | | | | | | | | | | Style |

For example, setting data for controlling capturing of an image corresponding to the calm sound pattern may include setting values of an aperture value, a shutter speed, and an ISO sensitivity. Here, that the controller 150 adjusts the aperture value by a ‘1-stop increase’ means that an aperture of the iris preset is closed by a preset value. For example, if the existing aperture value or an automatically set aperture value of the image processing apparatus 100 is ‘4 F’, then the ‘1-stop increase’ in the aperture value means that the aperture value is adjusted to ‘5.6 F’. That is, the ‘1-stop increase’ in the aperture value may be understood as increasing the aperture value by a predetermined level. That the controller 150 adjusts the shutter speed by a ‘1-stop decrease’ means that a time period in which the shutter is open is reduced by a preset amount. For example, if the existing shutter speed or an automatically set shutter speed of the image processing apparatus 100 is 1/500 sec, then the ‘1-stop decrease’ in the shutter speed means that the shutter speed is adjusted to 1/1000 sec. That is, the ‘1-stop decrease’ in the shutter speed may be understood as increasing the shutter speed by a predetermined level. The ISO sensitivity included in the mapping table may be expressed using a ‘1-step increase’ or a ‘1-step decrease’ instead of a setting value thereof to indicate a degree of change in the existing ISO sensitivity. Here, the ‘1-step increase’ denotes that existing ISO sensitivity is increased by one level. Also, a calm style may be used as the visual effect B, instead of the visual effect A, the setting data, or the image data processing mode corresponding to the calm sound pattern. Various shooting styles or visual effects described herein, such as the calm style, the vivid style, a black-and-white style, a sepia style, a landscape style, a cool style, a portrait style, a negative effect, the vignetting effect, and a miniature effect, may be, for example, those used in the Samsung cameras ST100, ST5000, NV24HD, and NX10/100 manufactured by Samsung Electronics Co., Ltd.

The visual effect A corresponding to the loud sound pattern may include image data processing modes, and the image data processing modes may include correction data for brightness, contrast, and chroma. In Table 1, the values mentioned in the ‘brightness’ column, the ‘contrast’ column, and the ‘chroma’ column may denote that image data to which no visual effect is added may be corrected by increasing or decreasing setting values of the image data by the mentioned values, respectively.

Table 2 shows a mapping table representing mapping information between a sound pattern classified as speech and a visual effect, according to another embodiment of the invention. In Table 2, the basic speech 1 and the basic speech 2 may be used when a speech cannot be classified, e.g., cannot be classified as a male pattern, a female pattern, or a child pattern. The controller 150 of the image processing apparatus 100 may classify calm speech as the basic speech 1 and loud speech as the basic speech 2.

TABLE 2

| | | Visual effect A | | | | | | | | | Visual |
|---|---|---|---|---|---|---|---|---|---|---|---|
| | | Setting data | | | | | | | | | effect B |
| | | | | ISO | | Image data processing mode | | | | | . |
| Classi- | Sound | Aperture | Shutter | sensi- | | | Bright- | | | | . |
| fication | pattern | value | Speed | tivity | . . . | Effect | ness | contrast | chroma | . . . | . |
| Speech | Male | — | — | — | . . . | — | — | +2 | — | . . . | Cool style |
| | Female | — | — | — | . . . | — | — | — | +1 | . . . | Portrait |
| | | | | | | | | | | | style |
| | Child | 1-stop | 1-stop | — | . . . | — | — | — | +2 | . . . | . |
| | | decrease | increase | | | | | | | | |
| | Basic | — | — | — | . . . | — | — | — | — | . . . | Soft focus |
| | speech 1 | | | | | | | | | | |
| | Basic | — | — | — | . . . | — | — | — | — | . . . | Synthetic |
| | speech 2 | | | | | | | | | | effect 4 |
| | | | | | | | | | | | (star/twin- |
| | | | | | | | | | | | kling ani- |
| | | | | | | | | | | | mation) |

For example, when a sound pattern is classified as the basic speech 1, a soft focus may be applied as a visual effect corresponding to the basic speech 1. The image processing apparatus 100 may obtain a soft image using soft focus. The controller 150 may control the imaging unit 130 or may process image data to apply the soft focus thereto to obtain an image to which soft focus is applied. If obtained sound has a sound pattern corresponding to the basic speech 2, the controller 150 may add the synthetic effect to captured image data in such a manner that stars or a twinkling animation object may be added to the captured image data. If the obtained sound is determined as a child pattern, the controller 150 may apply setting data corresponding to the child pattern to the imaging unit 130 and may also correct a captured image according to an image data processing mode corresponding to the child pattern.

Table 3 shows a mapping table representing mapping information between a sound pattern classified as music and a visual effect, according to another embodiment of the invention. In Table 3, basic music 1 and basic music 2 may be used when music cannot be classified, e.g., cannot be classified as a classical music pattern 1, a classical music pattern 2, a rock pattern 1, or a rock pattern 2. The controller 150 of the image processing apparatus 100 may classify calm music as the basic music 1, and loud music as the basic music 2. Whether the sound pattern is classified as either the classical music pattern 1 or 2, or the rock pattern 1 or 2 may be determined according to music genre.

TABLE 3

| | | Visual effect A | | | | | | | | | Visual |
|---|---|---|---|---|---|---|---|---|---|---|---|
| | | Setting data | | | | | | | | | effect B |
| | | | | ISO | | Image data processing mode | | | | | . |
| Classi- | Sound | Aperture | Shutter | sensi- | | | Bright- | | | | . |
| fication | pattern | value | Speed | tivity | . . . | Effect | ness | Contrast | Chroma | . . . | . |
| Music | Classic | — | — | — | . . . | Synthetic | 0 | +1 | −1 | . . . | Black-and- |
| | 1 | | | | | effect 1 | | | | | white/cine- |
| | | | | | | (fallen | | | | | ma style |
| | | | | | | leaves)- | | | | | |
| | Classic | — | — | — | . . . | Synthetic | 0 | −1 | −1 | . . . | Sepia/retro |
| | 2 | | | | | effect 2 | | | | | style |
| | | | | | | (piano | | | | | |
| | | | | | | keyboard | | | | | |
| | Rock 1 | — | 2-stop | — | . . . | — | +3 | +2 | +2 | . . . | Synthetic |
| | | | increase | | | | | | | | effect 3 |
| | | | | | | | | | | | (drum) |
| | Rock 2 | — | — | — | . . . | Negative | — | — | — | . . . | — |
| | Basic | — | — | — | . . . | Vignett- | +1 | +1 | +1 | . . . | Landscape |
| | music 1 | | | | | ing | | | | | style |
| | Basic | — | — | — | . . . | Minia- | — | +1 | +3 | . . . | — |
| | music 2 | | | | | ture | | | | | |

For example, when obtained sound is classified as the rock pattern 1, the controller 150 may apply a shutter speed corresponding to the rock pattern 1 to the imaging unit 130, and correct a captured image according to an image data processing mode corresponding to the rock pattern 1. Thus, the image processing apparatus 100 may obtain the captured image to which a ghost effect is added by adjusting the shutter speed by a ‘2-stop increase’, or may obtain luminous image data, the brightness and chroma of which are increased. According to another embodiment of the invention, the ‘effect’ column included in the ‘image data processing mode’ column in Table 3 may include a control signal, a command, an algorithm, or a program module for deriving the corresponding effect according to the image data processing mode.

In the mapping table stored in the memory unit 120 of the image processing apparatus 100, at least some part of Tables 1, 2, and/or 3 may be omitted or modified. Also, in the memory unit 120, some of or the entire mapping information included in Tables 1, 2 and/or 3 may be combined with information included in a different table.

In FIG. 4, each of an image 431 and an image 433 may be a captured image or image data to which visual effects corresponding to first sound patterns 421 and 423, respectively, are applied. The visual effects may be included in the mapping table stored in the memory unit 120.

If the strength of the obtained sound is ‘A’, then the controller 150 may obtain the image 431 by adjusting either at least some of preset setting data as or included in the first visual effect or a correction level of processing data of an image data processing mode according to the strength A. If the strength of the obtained sound is ‘B’, then the controller 150 may obtain the image 433 by adjusting either at least some of the preset setting data as or included in the first visual effect or the correction level of processing data of the image data processing mode according to the strength B. Here, the at least some of the preset setting data or the correction level of the processing data may be a value or data obtained by inputting the strength of the obtained sound to a preset equation, a preset function, a hardware module, or a software module. The memory unit 120 may store mapping information between either the adjusted preset setting data or the adjusted correction level of the processing data and the strength of the obtained sound. The controller 150 may access the adjusted preset setting data or correction level corresponding to the strength of the obtained sound. The correction level of the processing data may represent preset processing data corresponding to a predetermined amount or degree of a visual effect to obtain image data to which the predetermined amount or degree of the visual effect is added.

For example, the first sound patterns 421 and 423 may be wind sound patterns. The strength B of the obtained sound may be greater than the strength A of the obtained sound. In this case, the degree of a blue or green tone (or a ratio of the blue or green tone to other color tones) in the image 433 may be relatively higher than in the image 431. Also, the first sound patterns 421 and 423 may be calm sound patterns. The strength B of the obtained sound may be less than the strength A of the obtained sound. In this case, the brightness of the image 433 may be less than that of the image 431.

The controller 150 may also variously modify or adjust the degree of a visual effect added to an image according to the strength of the obtained sound. In the case of the vignetting effect, the controller 150 may adjust the size of an edge region of the image, which undergoes a darkening process, or may adjust the difference between the brightness of the edge region and the brightness of a central region of the image, according to the strength of the obtained sound. In the case of the synthetic effect of adding an object, the controller 150 may adjust the total number of or the size of objects synthesized according to the strength of the obtained sound. Accordingly, in the image processing apparatus 100, visual effects may be automatically and more delicately provided.

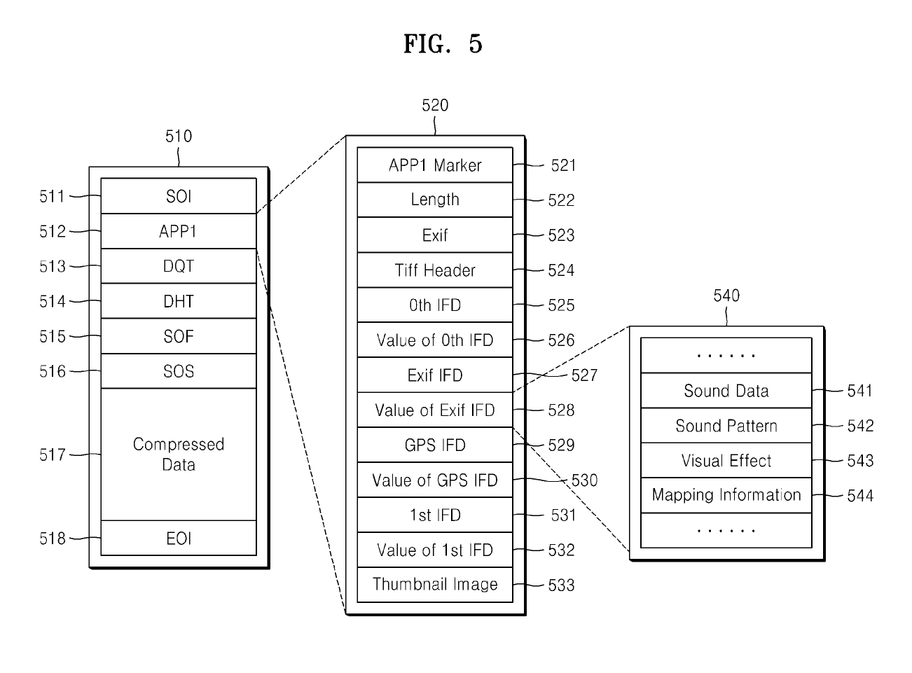

FIG. 5 illustrates an image data structure that includes mapping information between a sound pattern and a visual effect, according to an embodiment of the invention. The controller 150 of FIG. 1 may control capturing of an image or the imaging unit 130 of FIG. 1 to apply a preset visual effect corresponding to a determined sound pattern in a mapping table to a captured image, and/or may correct the captured image. Also, the controller 150 may generate an image data file (or compressed image data) by compressing either image data (or the captured image) obtained by controlling the capturing of an image or corrected image data obtained by correcting the captured image.

A JPEG format 510 will now be described as an example of the image data file or the compressed image data. The JPEG format 510 is divided into a plurality of markers (codes) 511 to 518 that are binary data each starting with ‘0xFF’. Each of the markers 511 to 518 may represent the start of data that contains information related thereto.

The JPEG format 510 may include, for example, an SOI marker 511, an APP1 marker 512, a DQT marker 513, a DHT marker 514, an SOF marker 515, an SOS marker 516, compressed image data 517, and/or an EOI marker 518. The SOI marker 511 may be related to the start of the image data. The APP1 marker 512 may be related to a user application. The DQT marker 513 may be related to a quantization table. The DHT marker 514 may be related to a Hoffman table. The SOF marker 515 may be related to a frame header. The SOS marker 517 may be related to a scan header. The EOI marker 518 may be related to the end of the image data.

Data related to the APP1 marker 512 may have an APP1 format 520 consisting of a plurality of marker codes 521 to 533. The APP1 format 520 may have data related to an Exif format and various attribute information, which may be divided into a plurality of marker codes 521 to 533. For example, the APP1 format 520 may include an APP1 marker 521, a length marker 522, an Exif marker 523, a Tiff Header marker 524, a 0th IFD marker 525, a value of 0th IFD marker 526, an Exif IFD marker 527, a value of Exif IFD marker 528, a GSP IFD marker 529, a value of the GSP IFD marker 530, a 1st IFD marker 531, a value of the 1st IFD marker 532, and/or thumbnail data 533. The APP1 marker 521 may be related to the location of a user application. The length marker 522 may be related to application size. The Exif marker 523 may be related to Exif identification code. The Tiff Header marker 524 may be related to an offset for referring to an IFD address. The 0th IFD marker 525 may be related to attribute information of major image data, e.g., image size, an Exif IFD pointer, and a GPS IFD pointer. The Value 0th IFD marker 526 may be related to data values for information included in a 0th IFD. The Exif IFD maker 527 may include attribute information of the Exif format. The Value of Exif IFD marker 528 may be related to data values for information included in the Exif IFD marker 527. The GPS IFD marker 529 may be related to GPS information of image data. The Value of the GPS IFD marker 530 may be related to data values for information included in a GPS IFD. The 1st IFD marker 531 may be related to attribute information of thumbnail data of image data. The Value of the 1st IFD marker 532 may be related to data values for information included in a 1st IFD.

The controller 150 may include a data region 540 related to the Value of Exif IFD 528 that includes audio data 541, a sound pattern 542, visual effect information 543, and/or mapping information 544. The audio data 541 may be data representing a sound obtained by the sound sensor 110 of the image processing apparatus 100. If the data representing the obtained sound is included, then the size of the audio data 541 may need to be smaller than 64 KB to comply with current JPEG standards in which the size of the APP1 format 521 is limited to be 64 KB or less in the data region 540 related to the Value of Exif IFD marker 528. The sound pattern 542 may be information regarding a sound identifier that identifies a particular sound pattern from among preset sound patterns. The visual effect information 543 may be information regarding a visual effect identifier that identifies a visual effect that corresponds to the sound pattern 542 and is applied to image data. The mapping information 544 may be identification information regarding mapping information that represents a visual effect corresponding to a particular sound pattern in the mapping table stored in the memory unit 120. For example, if a mapping table is standardized and mapping information between sound patterns and visual effects are predetermined, the mapping information 544 may be expressed using an index to reduce the overhead of information. In this case, the memory unit 120 in the image processing apparatus 100 or an external image processing apparatus may store the index and connection information between a plurality of pieces of mapping information. Also, the controller 150 may also control identification information regarding the sound pattern 542 and/or the visual effect information 543 included in compressed image data or an image data file, in the form of data, the size of which may be as small as an index.

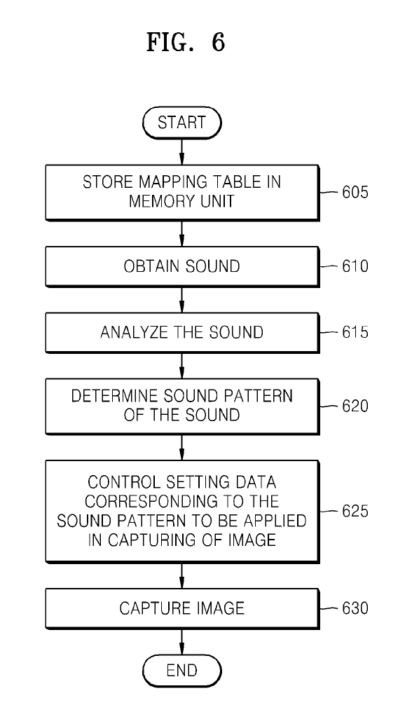

Image processing methods performed by, for example, the image processing apparatus 100 of FIG. 1, according to embodiments of the invention, will now be described with reference to FIGS. 6 to 8.

FIG. 6 is a flowchart illustrating an image processing method, according to an embodiment of the invention. In FIG. 6, in operation 605, a mapping table may be stored in the memory unit 120 of the image processing apparatus 100. In the mapping table, at least one of preset sound patterns corresponds to at least one piece of preset setting data for controlling capturing of an image.

In operation 610, the user interface unit of the image processing apparatus 100 may receive a signal for activating the hybrid mode from a user. Also, the sound sensor 110 of the image processing apparatus 100 may obtain a sound.

In operation 615, the controller 150 (e.g., the analysis unit 151) of the image processing apparatus 100 may analyze the obtained sound. The controller 150 may also obtain analysis data that includes the time-domain characteristics and/or frequency-domain characteristics of the obtained sound by analyzing the obtained sound.

In operation 620, the controller 150 (e.g., the determination unit 153) may determine a preset sound pattern from among the preset sound patterns to be a sound pattern of the obtained sound based on the analysis data.

In operation 625, the controller 150 (e.g., the image processor 157) may capture an image using preset setting data corresponding to the determined sound pattern mapping table from among the at least one piece of preset setting data in the mapping table. Also, the controller 150 may capture an image by adjusting at least some of preset setting data, which corresponds to a sound pattern determined according to the strength of the obtained sound. The preset setting data may include at least one from among an aperture value, a shutter speed, an ISO sensitivity, and an image sensor setting value.

As described above, in the image processing apparatus 100, a sound pattern may be automatically determined to obtain a visual effect corresponding to an ambient environment or sound when an image is captured, and setting data corresponding to the sound pattern may be reflected in the capturing of the image.

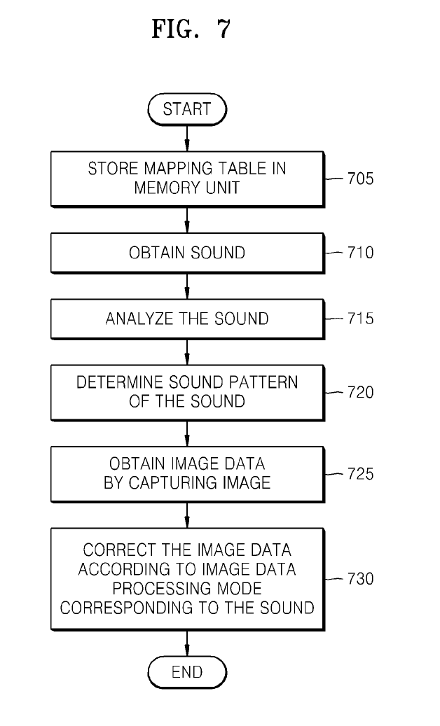

FIG. 7 is a flowchart illustrating an image processing method, according to another embodiment of the invention. In FIG. 7, in operation 705, in the memory unit 120 of the image processing apparatus 100, mapping data representing that at least one of preset sound patterns corresponds to at least one image data processing mode for correcting image data may be stored. Here, the at least one image data processing mode may include correction data regarding at least one from among brightness, chroma, contrast, and color balance. Also, the at least one image data processing mode may include processing data regarding at least one from among the vignetting effect, the fish eye effect, the watercolor painting effect, and the synthetic effect of adding an object.

In operation 710, the user interface unit of the image processing apparatus 100 may receive a signal for activating the hybrid mode from a user. Also, the sound sensor 110 of the image processing apparatus 100 may obtain a sound.

In operation 715, the controller 150 (e.g., the analysis unit 151) of the image processing apparatus 100 may analyze the obtained sound. Also, the controller 150 may obtain analysis data that includes the time-domain characteristics and/or frequency-domain characteristics of the obtained sound by analyzing the obtained sound.

In operation 720, the controller 150 (e.g., the determination unit 153) may determine a preset sound pattern from among preset sound patterns to be a sound pattern of the obtained sound based on the analysis data.

In operation 725, the imaging unit 130 of the image processing apparatus 100 may obtain image data or a captured image by capturing an image.

In operation 730, the controller 150 (e.g., the image processor 157) may correct the image data according to an image data processing mode corresponding to the determined sound pattern in a mapping table. Also, the controller 150 may adjust the level of correction data or processing data of an image data processing mode corresponding to a sound pattern determined according to the strength of the obtained sound. Accordingly, the image processing apparatus 100 may correct the image data in such a manner that a visual effect corresponding to a user's experience related to sound may be applied to the image data.

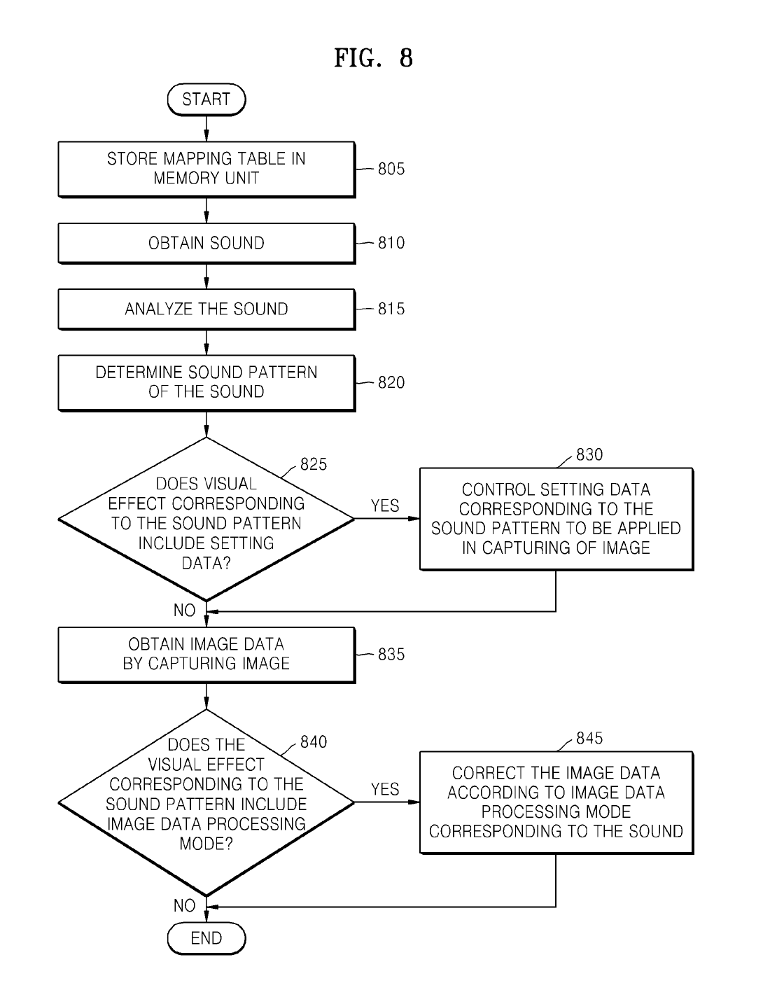

FIG. 8 is a flowchart illustrating an image processing method, according to yet another embodiment of the invention. In FIG. 8, in operation 805, in the memory unit 120 of the image processing apparatus 100, a mapping table in which preset sound patterns correspond to preset visual effects, respectively, may be stored.

In operation 810, the user interface unit of the image processing apparatus 100 may receive a signal for activating the hybrid mode from a user. Also, the sound sensor 110 of the image processing apparatus 100 may obtain a sound.

In operation 815, the controller 150 (e.g., the analysis unit 151) of the image processing apparatus 100 may analyze the obtained sound. Also, the controller 150 may obtain analysis data that includes the time-domain characteristics and/or frequency-domain characteristics of the obtained sound by analyzing the obtained sound.

In operation 820, the controller 150 (e.g., the determination unit 153) may determine a preset sound pattern from among preset sound patterns to be a sound pattern of the obtained sound, based on the analysis data.

The controller 150 (e.g., the image processor 157) may apply setting data for controlling capturing of an image or the imaging unit 130 to add (apply) a preset visual effect corresponding to the determined sound pattern in the mapping table to the captured image, and/or may correct the captured image. Operations 825, 830, 835, 840 and 845 related to operations of the imaging unit 130 and/or the controller 150 performed after operation 820 will now be described in greater detail.

In operation 825, the controller 150 may determine whether the preset visual effect corresponding to the determined sound pattern includes setting data. Here, the setting data may include at least one from among an aperture value, a shutter speed, an ISO sensitivity, and an image sensor setting value. If the preset visual effect corresponding to the determined sound pattern does not include setting data, the image processing apparatus 100 may proceed to operation 835.

If the preset visual effect corresponding to the determined sound pattern includes setting data, then in operation 830, the controller 150 may control the included setting data to be applied to the imaging unit 130 to control the operation of the imaging unit 130.

In operation 835, the imaging unit 130 may obtain image data or a captured image by capturing an image.

In operation 840, the controller 150 may determine whether the preset visual effect corresponding to the determined sound pattern includes an image data processing mode. Here, the image data processing mode may include correction data regarding at least one from among brightness, chroma, contrast, and color balance. The image data processing mode may include processing data regarding at least one from among the vignetting effect, the fish eye effect, the watercolor painting effect, and the synthetic effect of adding an object. If the preset visual effect corresponding to the determined sound pattern does not include an image data processing mode, the image processing method of FIG. 8 may end.

If the preset visual effect corresponding to the determined sound pattern includes an image data processing mode, then in operation 845, the controller 150 (e.g., the image processor 157) may correct the captured image according to the image data processing mode.

Also, the controller 150 may adjust the level of correction data or processing data of an image data processing mode, which is included in a preset visual effect corresponding to a sound pattern determined according to the strength of the obtained sound. Also, the controller 150 may adjust some of preset setting data, which is included in the preset visual effect corresponding to the sound pattern determined according to the strength of the obtained sound. The preset setting data includes at least one from among an aperture value, a shutter speed, an ISO sensitivity, and an image sensor setting value.

In one embodiment of the invention, the image processing apparatus 100 of FIG. 1 may include the memory unit 120 and the controller 150. A process of processing an image performed by the memory unit 120 and the controller 150 of the image processing apparatus 100, according to an embodiment of the invention, will now be described.

The memory unit 120 may store audio data and image data. For example, the memory unit 120 may receive audio data of ambient sound of the image processing apparatus 100 from the sound sensor 110. Also, the memory unit 120 may receive a captured image or image data from the imaging unit 130. Also, the memory unit 120 may receive audio data and/or image data from an external device (or a network) connected to the image processing apparatus 100 via an interface unit (not shown) or by communicating with an external device (or a network). The memory unit 120 may store the received audio data and/or image data.

The controller 150 may receive the audio data from the memory unit 120, and may receive image data from the memory unit 120.

Also, the controller 150 may correct the image data in such a manner that a preset visual effect corresponding to the audio data may be added to the image data. A method of correcting the image data by the controller 150 has been described above.

The embodiments described herein may comprise a memory for storing program data, a processor for executing the program data, a permanent storage such as a disk drive, a communications port for handling communications with external devices, and user interface devices, including a display, keys, etc. When software modules are involved, these software modules may be stored as program instructions or computer-readable codes, which are executable by the processor, on a non-transitory or tangible computer-readable media such as read-only memory (ROM), random-access memory (RAM), a compact disc (CD), a digital versatile disc (DVD), magnetic tapes, floppy disks, optical data storage devices, an electronic storage media (e.g., an integrated circuit (IC), an electronically erasable programmable read-only memory (EEPROM), and/or a flash memory), a quantum storage device, a cache, and/or any other storage media in which information may be stored for any duration (e.g., for extended time periods, permanently, brief instances, for temporarily buffering, and/or for caching of the information). The computer-readable recording medium can also be distributed over network-coupled computer systems (e.g., a network-attached storage device, a server-based storage device, and/or a shared network storage device) so that the computer-readable code may be stored and executed in a distributed fashion. This media can be read by the computer, stored in the memory, and executed by the processor. As used herein, a computer-readable storage medium excludes any computer-readable media on which signals may be propagated. However, a computer-readable storage medium may include internal signal traces and/or internal signal paths carrying electrical signals therein

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as” or “for example”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. An image processing apparatus comprising:
a memory unit for storing a mapping table, the mapping table representing that at least one of preset sound patterns corresponds to at least one piece of preset setting data for controlling image capturing;
a sound sensor for obtaining sound;
a controller for determining one of the preset sound patterns to be a sound pattern of the obtained sound; and
an imaging unit for capturing an image,
wherein the controller applies to the imaging unit preset setting data corresponding to the sound pattern from among the at least one piece of preset setting data in the mapping table.

2. The image processing apparatus of claim 1, wherein each of the at least one piece of preset setting data comprises at least one from among an aperture value, a shutter speed, an International Standards Organization (ISO) sensitivity, and an image sensor setting value.

3. The image processing apparatus of claim 2, wherein the preset sound patterns comprises a first pattern and a second pattern,
wherein the first pattern corresponds to first data as the at least one piece of preset setting data in the mapping table,
the second pattern corresponds to second data as the at least one piece of preset setting data in the mapping table, and
at least one of a first condition whereby an aperture value included in the first data is greater than an aperture value included in the second data and a second condition whereby a shutter speed included in the first data is faster than a shutter speed included in the second data is satisfied.

4. The image processing apparatus of claim 3, wherein time-domain characteristics of the first pattern are different from time-domain characteristics of the second pattern, or frequency-domain characteristics of the first pattern are different from frequency-domain characteristics of the second pattern,
wherein each of the time-domain characteristics comprises at least one from among an amplitude variation in the time domain and an autocorrelation, and
wherein each of the frequency-domain characteristics comprises frequency distribution characteristics.

5. The image processing apparatus of claim 1, wherein the controller adjusts at least some of second preset setting data corresponding to a sound pattern determined according to a strength of the obtained sound,
wherein the second preset setting data comprises at least one from among an aperture value, a shutter speed, an International Standards Organization (ISO) sensitivity, and an image sensor setting value.

6. An image processing method comprising:
storing a mapping table in a memory unit, the mapping table representing that at least one of preset sound patterns corresponds to at least one piece of preset setting data for controlling image capturing;
obtaining a sound;
determining one of the preset sound patterns to be a sound pattern of the obtained sound; and
capturing an image by applying preset setting data corresponding to the determined sound pattern from among the at least one piece of preset setting data in the mapping table.

7. The image processing method of claim 6, wherein each of the at least one piece of preset setting data comprises at least one from among an aperture value, a shutter speed, an International Standards Organization (ISO) sensitivity, and an image sensor setting value.

8. The image processing method of claim 7, wherein the preset sound patterns comprises a first pattern and a second pattern,
wherein the first pattern corresponds to first data as the at least one piece of preset setting data in the mapping table,
the second pattern corresponds to second data as the at least one piece of preset setting data in the mapping table, and
at least one of a first condition whereby an aperture value included in the first data is greater than an aperture value included in the second data and a second condition whereby a shutter speed included in the first data is faster than a shutter speed included in the second data is satisfied.

9. The image processing method of claim 8, wherein time-domain characteristics of the first pattern are different from time-domain characteristics of the second pattern, or frequency-domain characteristics of the first pattern are different from frequency-domain characteristics of the second pattern,
wherein each of the time-domain characteristics comprises at least one from among an amplitude variation in the time domain and an autocorrelation, and
wherein each of the frequency-domain characteristics comprises frequency distribution characteristics.

10. The image processing method of claim 6, wherein the capturing of the image comprises adjusts at least some of preset setting data corresponding to a sound pattern determined according to a strength of the obtained sound, and
wherein the preset setting data comprises at least one from among an aperture value, a shutter speed, an International Standards Organization (ISO) sensitivity, and an image sensor setting value.

11. An image processing apparatus comprising:
a memory unit for storing a mapping table in a memory unit, the mapping table representing that preset sound patterns correspond to preset visual effects, respectively;
a sound sensor for obtaining sound;
a controller for determining one of the preset sound patterns to be a sound pattern of the obtained sound; and
an imaging unit for capturing an image,
wherein the controller performs at least one of:
controlling the imaging unit to apply a preset visual effect corresponding to the determined sound pattern in the mapping table to the captured image; and
correcting the captured image corresponding to the determined sound pattern in the mapping table to the captured image.

12. The image processing apparatus of claim 11, wherein at least one of the preset visual effects comprises setting data for controlling the capturing of the image, the setting image comprising at least one from among an aperture value, a shutter speed, an International Standards Organization (ISO) sensitivity, and an image sensor setting value.

13. The image processing apparatus of claim 12, wherein the controller controls an operation of the imaging unit by applying setting data included in the preset visual effect corresponding to the determined sound pattern to the imaging unit.

14. The image processing apparatus of claim 11, wherein at least one of the preset visual effects comprises an image data processing mode for correcting the captured image.

15. The image processing apparatus of claim 14, wherein the controller corrects the captured image by correcting the captured image according to an image data processing mode included in the preset visual effect corresponding to the determined sound pattern.

16. The image processing apparatus of claim 14, wherein the image data processing mode comprises correction data regarding at least one from among brightness, chroma, contrast, and color balance, and
the controller controls correction data of an image data processing mode included in a preset visual effect corresponding to a sound pattern determined according to a strength of the obtained sound.

17. The image processing apparatus of claim 14, wherein the image data processing mode comprises processing data regarding at least one from among a vignetting effect, a fish eye effect, a watercolor painting effect, and a synthetic effect of adding an object, and
the controller adjusts a correction level of processing data of an image data processing mode, which is included in a preset visual effect corresponding to a sound pattern determined according to a strength of the obtained sound.

18. An image processing method comprising:
storing a mapping table in a memory unit, the mapping table representing that preset sound patterns correspond to preset visual effects, respectively;
obtaining a sound;
determining one of the preset sound patterns to be a sound pattern of the obtained sound; and
capturing an image,
wherein the capturing of the image comprises at least one of:
applying setting data for controlling the capturing of the image to apply a preset visual effect corresponding to the determined sound pattern in the mapping table to the captured image; and
correcting the captured image corresponding to the determined sound pattern in the mapping table to the captured image.

19. An image processing apparatus comprising:
a memory unit for storing a mapping table representing that at least one of preset sound patterns corresponds to at least one image data processing mode for correcting image data;
a sound sensor for obtaining a sound;
a controller for determining one of the preset sound patterns to be a sound pattern of the obtained sound; and
an imaging unit for obtaining the image data by capturing an image,
the controller to adjust the image data according to an image data processing mode corresponding to the determined sound pattern from among the at least one image data processing mode in the mapping table.

20. An image processing method comprising:
storing a mapping table in a memory unit, the mapping table representing that at least one of preset sound patterns corresponds to at least one image data processing mode for correcting image data;
obtaining a sound;
determining one of the preset sound patterns to be a sound pattern of the obtained sound;
obtaining the image data by capturing an image; and
adjusting the image data according to an image data processing mode corresponding to the determined sound pattern from among the at least one image data processing mode in the mapping table.

21. An image processing apparatus comprising:
a memory unit for storing audio data and image data; and
a controller for receiving the audio data, receiving the image data, and
adjusting the image data by applying to the image data a preset visual effect corresponding to the audio data.

22. An image processing method comprising:
receiving audio data;
receiving image data; and
adjust the image data by applying a preset visual effect corresponding to the audio data to the image data.
